(19) United States
(12) Patent Application Publication
(10) Pub. No.: US 2009/0097700 A1
(43) Pub. Date: Apr. 16, 2009

(54) METHOD OF DATA CAPTURE AND RECOGNITION

(76) Inventors: Todd Fishback, Omaha, NE (US); Tu Nguyen, Omaha, NE (US)

Correspondence Address: HUSCH BLACKWELL SANDERS LLP, 1620 DODGE STREET, SUITE 2100, OMAHA, NE, 68102, US

(21) Appl. No.: 12/249,026

(22) Filed: Oct. 10, 2008

Related U.S. Application Data
(60) Provisional application No. 60/979,026, filed on Oct. 10, 2007.

(51) Int. Cl. G06K 9/00

(52) U.S. Cl. 382/100

(57) ABSTRACT

A method of capturing data from a form is disclosed. The form is completed by a user. The form is identified from a library of forms by recognizing an overall layout of the form. Fields on the form correlating to data fields completed by the user are identified, and data from the data fields is captured and stored.

### CROSS REFERENCE TO RELATED APPLICATION

This application is a continuation of and claims the benefit of and priority to U.S. Provisional Patent Application No. 60/979,026, filed Oct. 10, 2007, entitled METHOD OF DATA CAPTUE AND RECOGNITION, which document is hereby incorporated by reference to the extent permitted by law.

### BACKGROUND

Computer storage of data greatly increases the ability of users to search, revise, and evaluate the data. However, much data is still collected on hard copy documents filled out by hand or machine. Accordingly, there is a need for a system for reading and storing data electronically from hard copy forms.

### BRIEF DESCRIPTION OF THE DRAWINGS

FIG. 1 is a comparative schematic of data storage and access systems.

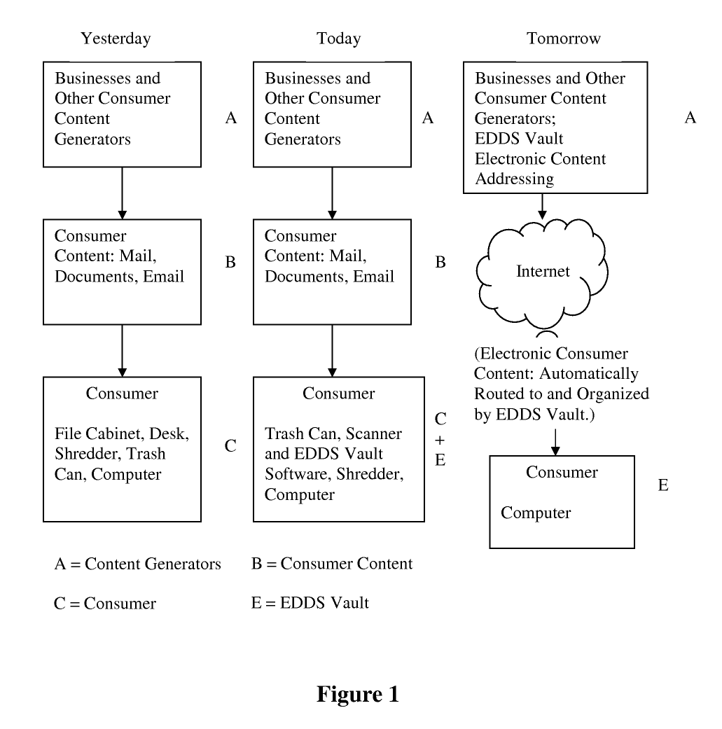

### DETAILED DESCRIPTION

### Form Template Recognition

When recognizing a form, previous technologies look for an anchor field or a landmark field, such as a logo or word. The challenge with this approach is that if the anchor or landmark field is torn or stained, the accuracy of the recognition goes down.

In contrast, the EDDS Vault's singular approach is to recognize the entire form as a unit. The EDDS Vault form template recognition starts with a blank template—the form with no data. EDDS Vault recognizes the entire layout of the template as the “landmark field.” Therefore, a corner can be torn off the document or the document may have a stain but recognition is still good.

### Form Data Recognition

For form data recognition, most applications ask the user to draw zones on the form that the application will recognize, such as a last name field. When you do this, you capture the lines of the box surrounding the field, which can interfere with the recognition of the data. Furthermore, the user must be careful not to accidentally capture part of another zone or the application may associate data that should be on one zone with another zone.

In contrast, EDDS Vault technology uses a unique method that removes the text box lines and other markings from the template before recognition. This improves the accuracy of the recognition since there are no lines or other elements that can interfere with the recognition of the user-entered data. Removing lines provides more uninterrupted white space between data so that the zones are easier for the application to distinguish.

Other products attempt to improve their recognition by enabling the user to modify the zones and change the image quality during the process of recognizing a batch of documents. The drawback is that this method only improves the ability of the system to recognize the form being “tweaked,” since the next item in the batch may not have the same characteristics as the one the user worked on. For batch processing, EDDS Vault's method is superior since recognition is better for the batch overall.

### EDDS Vault Home Edition

EDDS Vault Home Edition is a system providing the individual with content management system efficiencies traditionally reserved for businesses or organizations. It packages and provides to the individual in a unique manner various content management functionalities via a software system that includes software installed on a personal computer and virtual repositories that may be local or on the EDDS Vault secure server accessible via the Internet. These functionalities include, but are not limited to, the ability to organize content, search for content, recognize content, manage user's rights in relation to content, version content, use content in workflows, and manipulate content.

In addition to packaging and providing traditionally business- or organization-oriented content management functionalities to the consumer, the EDDS Vault Home Edition also includes functionality new to the market. The functionalities unique to EDDS Vault Home Edition enable individuals to enjoy a more “paperless” lifestyle. They include the electronic storage of tax documents in a virtual structure, automated content sorting functionality, and automated content “addressing” functionality that allows an EDDS Vault Home Edition repository to receive and sort electronic content directly from content generators.

EDDS Vault Home Edition provides these functionalities via the following major components: 1) EDDS Vault Home Edition software, which may be installed on a personal computer to provide a virtual interface or portal to view and manipulate content stored on the EDDS Vault Home Edition repository, in addition to other functionalities; 2) EDDS Vault Home Edition virtual repository, which may be located on a personal computer and/or a secure server accessible to authenticated users over the Internet and/or other devices and which serves to hold electronic content.

### Packaging and Providing Content Management System Functionalities for the Individual

Large organizations have long known the benefits of content management systems, which are software systems used to manage content. Content typically managed in these systems includes electronic files, image files, audio files, and web content.

Content management systems enable companies to reduce paper and improve operating efficiency. Such systems may enable users to capture physical content, like text and/or images on paper, and convert it into electronic content, such as an image file with associated metadata. These systems also typically enable upload, organization, manipulation, and storage of converted and other content, such as electronic files, image files, audio files, etc. They usually enable users to organize the content via a user interface, and they provide access to content to multiple users, often in different offices. The systems typically include presentation of and access to specific content via a user interface that often contains virtual structural elements like directories or folders, along with administrative ability to control user's rights to specific content.

Local and/or Online Storage of Content—EDDS Vault Home Edition enables the individual to access and manage his or her electronic content. One way this can be accomplished is when an individual
1) Installs EDDS Vault Home Edition on a personal computer
2) Creates virtual file cabinets and folders in the EDDS Vault Home Edition user interface that serves to visually organize content
3) Uses the interface to manage content stored in an EDDS Vault Home Edition repository on a local computer, on an EDDS Vault secure server accessible via the Internet (on-line repository), and/or on another device. EDDS Vault Home Edition uses security measures to keep content safe, such as one-way encryption. The user might choose to enable automatic mirroring of local content to the Internet server or another device for purposes of backup and accessibility any time, from around the globe.

Find Content Rapidly—EDDS Vault Home Edition brings to the individual the same rapid search-and-find capabilities for content availed organizations and businesses. For example, organization and business content management systems often include the ability to automatically or manually add index values to content, which search engines then use to speed delivery of search items. EDDS Vault Home Edition uses methodology that enables the user to search for and find content faster than typical methods available to individuals, such as an operating system file search.

System Content Recognition—When physical content like data on paper is scanned into a system, the resulting electronic version is like a picture. For example, the system cannot recognize any text content in this image file and users cannot perform functions like copying or editing the text content. However, technology can be applied that recognizes and stores text content in order for users to be able to search on it and manipulate it. An example of this technology used in the industry today is Optical Character Recognition (OCR). Another example is the ability for some systems to recognize certain elements of image files, such as facial characteristics of people in images.

EDDS Vault Home Edition brings to the individual the ability for the system to recognize and store certain content for use with other functionality in the system or with other systems. For example, this functionality might be used to enable the system to recognize fields on documents like receipts, bank statements, and credit card statements and export them into any tax preparation or bookkeeping software.

Management of User's Rights—Content management systems used for organizations and businesses typically include the ability for administrators to manage which users can perform which functions on specific content. For example, administrators of a content management system might set up various roles that users are assigned to. The roles then control the users' rights within the system, such as those users' ability to create, read, update, and/or delete certain content in the system. This setup enables multiple users to access content in a secure and organized fashion, improving, for example, the ability of an organization to work collaboratively. EDDS Vault Home Edition provides the individual content owner with similar abilities to control what either public or other authorized users can do with certain content in the system.

For example, the ability of the content owner using EDDS Vault Home Edition to manage user's rights might enable the owner to:
Securely share certain documents with certain authorized users over the Internet, eliminating the issue of sensitive information on a disk being lost or stolen
Collaborate with others on specific content school or work projects from a home office
Provide specific tax information to a tax professional electronically
Share specific photos, recipes, and event information with family and friends, all around the globe
Provide specific personal copies of medical records to various medical professionals
Provide specific auto maintenance records to mechanics or potential buyers
Access car insurance and road assistance information on the road o Maintain important documents for themselves or their loved ones in event of a natural disaster or death to be accessed by specific users only

Versioning—Some content management systems provide businesses the ability to maintain and track different versions of content in the system. This functionality is especially helpful if more than one user is working on content. EDDS Vault Home Edition provides this capability to the individual. As an example, an individual using EDDS Vault Home Edition might use versioning when collaborating with others on school or work projects from home.

Workflow—Some content management systems provide businesses with workflow functionality, which enables the system to add automation to the workflow process content is involved in. This might include sending email notifications based on changes in the content's location or status in the system or automatic archival of content after a certain date. EDDS Vault Home Edition enables the individual to use workflow functionality for the individual's content. For example, a user could set up the system to send an email if an item is loaded into a folder holding bills to pay this week or if the system added content in an automated fashion, such as receipt of email.

Content Manipulation—Some content management systems allow businesses to add annotations, such as electronic “sticky notes” to content. In addition, some allow businesses to redact, or “white out” content. Similar functionality is provided the individual in EDDS Vault Home Edition.

### Unique Concepts to Provide a More Paperless Lifestyle

EDDS Vault Home Edition system offers unique new concepts to the individual that work together to enable the individual to lead a more “paperless” lifestyle. They include, but are not limited to, the following functionalities:

Automatic Sorting Functionality—EDDS Vault Home Edition contains automatic sorting functionality that recognizes characteristics of content and then makes that content available to the authorized user in a virtual structure in the user interface, such as virtual file cabinets and drawers. For example, this technology might sort documents by file extensions, common content formats, like as business cards or receipts, content with certain logos like bank or credit card statements, or images of people based on the ability of the software to recognize and/or interpret facial characteristics.

Automatic Electronic Content Addressing Functionality—Businesses and other consumer content generators use EDDS Vault automatic electronic content addresses to route electronic documents to consumers' EDDS Vault. Examples of such content might include:
Receipts
Warranties
Bank and Credit Card Statements
Bills
School Communications
Legal Documents
Tax Documents
Investor Information
Paycheck Stubs
Medical Records
Insurance Information
Auto Maintenance Records

DOCCENTER provides the content generators with the information they need to add automatic electronic content addresses that direct content not only to a specific EDDS Vault Home Edition user's repository, but also, optionally, to a specific virtual structure element, like a virtual file cabinet or drawer, in the repository. Content providers might also push advertising content for the user to an appropriate virtual structure element.

EDDS Vault organizes documents into such virtual file cabinets and drawers based on information contained in the address and may perform other tasks like adding parsed dates to an EDDS Vault master calendar and parsed contact information to an EDDS Vault contact manager. The consumer might receive notices of newly added content, access content in appropriate virtual file cabinets and drawers, view dates in master calendar, and view contact manager information.

For example, when an EDDS Vault Home Edition user makes a purchase from a participating merchant, the user's electronic receipt might be automatically filed in EDDS Vault Home Edition in an appropriate virtual structure element, such as a virtual file cabinet or drawer. When the user receives an electronic bank statement, the statement would be automatically filed in EDDS Vault Home Edition in an appropriate virtual structure element. When a content generator sends a bill using electronic content addressing functionality, the bill could be automatically filed and the due date entered on the EDDS Vault Home Edition master calendar. Contact information might be parsed and routed to an EDDS Vault contact manager.

The result of content generators using automatic electronic content addressing functionality is that the consumer's labor is no longer part of the process flow in the handling and processing of content. Content flows directly from the content generators to specific virtual structures within the consumer's EDDS Vault repository. Refer to the following illustration.

Electronic Tax Preparation Kit Functionality—EDDS Vault Home Edition enables the individual to organize electronic tax preparation information content that resides an EDDS Vault Home Edition repository so that it is visible and accessible in a virtual structure that mirrors the physical Tax Preparation Kit file structure. EDDS Vault Home Edition provides all its functionalities for electronic tax preparation information.

As is the case with other types of content, tax preparation information content generators can use automatic addressing technology to direct content to an individual's EDDS Vault Home Edition repository so that the content is visible and available to an authorized user in the appropriate virtual structure element. In addition, tax information content generators might direct advertising to appear in an appropriate virtual structure element as well.

Once content is available to EDDS Vault Home Edition, which might occur via tax preparation information content generators' use of automatic addressing functionality or user upload or other means, automatic sorting technology makes the content visible and available to the user via an appropriate virtual structure in the user interface, such as a virtual cabinet or virtual folder. Users can enable a tax professional to access this information securely online via the EDDS Vault online repository, eliminating the need to carry paper documents, email electronic documents, or carry disks with electronic documents with sensitive information that could be lost.

EDDS Vault Customize, Repackage, and Redistribute Marketing Strategy

Some of DOCCENTER's EDDS Vault software products include a feature that enables EDDS Vault customers to easily customize, repackage, and distribute it to their own customers, who can then customize, repackage, and distribute it to their customers, and so on, creating a vast network of users. DOCCENTER does not need to market directly to customers by relying on selling the application in a store or on the hiltemet.

Instead, EDDS Vault products contain a feature that enables customers to save a copy of the software they have customized for their own customers in some manner that can be transferred, such as via a download or a storage device like a compact disc (CD). While distributing products via a tiered approach is not unique, DOCCENTER does not receive money as a direct result of the application being redistributed. The entity redistributing EDDS Vault may sell it to others, but DOCCENTER does not receive funds from the resale. Instead, DOCCENTER receives the benefit of some users choosing to store their content on DOCCENTER's secure repository and the benefit of building a mass of users. This mass of users then encourages content generators to use automatic electronic content addressing functionality. As more content generators use automatic electronic content addressing functionality, more individuals realize the benefit of using EDDS Vault.

An example of how this strategy works is via an accounting practice. For each of the accountant's clients, the accountant creates a copy of EDDS Vault that may contain the client's electronic tax return and supporting documents. The client's version of EDDS Vault has the same features and functionality as the accountant's version. The client can then use EDDS Vault as he or she wishes, and can subsequently create additional copies of the EDDS Vault software for friends and family, saving to EDDS Vault the content to be shared with each friend or family member. The client's friend or family member now has a version of EDDS Vault software with the same features and functionality as the version that started with the accountant. The friend or family member can create and share EDDS Vault software with others, and so on.

What is claimed is:

1. A method of capturing data from a form completed by a user comprising: identifying the form from a library of forms by recognizing an overall layout of the form; identifying fields on the form correlating to data fields completed by the user; capturing data from the data fields; and storing the captured data.

2. The method of claim 1, wherein the captured data is stored on a server accessed via the Internet.

3. The method of claim 1, wherein the form is a tax form.
